(19) United States
(12) Patent Application Publication
(10) Pub. No.: US 2006/0092915 A1
(43) Pub. Date: May 4, 2006

(54) Methods and systems for accessing information across a network

(75) Inventor: Wayne Markeis Moore, Lawrenceville, GA (US)

Correspondence Address: BELLSOUTH CORPORATION, P.O. BOX 2903, MINNEAPOLIS, MN, 55402-0903, US

(73) Assignee: BellSouth Intellectual Property Management Corporation

(21) Appl. No.: 10/976,136

(22) Filed: Oct. 28, 2004

(51) Int. Cl. H04L 12/66

(52) U.S. Cl. 370/352; 370/401

(57) ABSTRACT

Systems and methods are provided for accessing information from a network, including a voice-enabled transceiving device enabling a user to request information from the network, such as the Internet, using simple voice commands. The systems and methods utilize a Key Word Identifier (KWI) application to package the user's request and route the request to a network. The network includes a Voice Gateway Server (VGS), which also includes a KWI application, operating to provide the user with the requested information, such as a web page or link, without having to point or click a mouse, thereby providing substantially hands-free operation.

### FIELD OF THE INVENTION

The present invention generally relates to methods and systems for accessing information across a network. More particularly, the present invention relates to methods and systems for accessing information across a network using a voice-enabled communication device.

### BACKGROUND OF THE INVENTION

With the advent of the computer age, computer users have grown accustomed to user-friendly applications that help them perform a variety of everyday tasks, such as financial planning, word processing, electronic mail, calendar organization, presentation preparation, and the like. In recent years, there has also been explosive growth of the Internet and network services. Information services offered over the Internet are utilized more and more by individuals and businesses to retrieve various types of information. Typically, a user utilizing a personal computer and a modem dials into a service provider, such as an Internet gateway, an on-line service, or an electronic bulletin board to download information according to the user's needs.

However, the hardware and software which enable computer information access are typically complex systems. Information, though widely available, may be difficult to access due to limited operating systems, connectivity issues, and network configuration limitations. Generally, significant amounts of time and effort may be required of those who use and depend on these systems and services to communicate and obtain information. Furthermore, disabled and novice computer users may have difficulty using typical computer equipment making the task of retrieving information all the more difficult. Disabled and computer illiterate users may require specialized equipment and training to surf the Internet for information. Thus, there is a need for systems and equipment which enable a disabled, multitasking, computer illiterate, and/or other users to efficiently access information from and communicate over a network, such as the Internet.

### SUMMARY OF THE INVENTION

According to embodiments of the present invention, methods and systems are for efficiently accessing information from a network using a communication device. According to one embodiment of the invention, a system and method are for accessing information from a network, including a voice-enabled transceiver which enables a user to request information from the network, such as the Internet, using simple voice commands. The system and method utilize a Key Word Identifier (KWI) application to package the user's request and route the request to a network. One aspect of the invention includes a network having a Voice Gateway Server (VGS), which includes a KWI application, operating to provide the user with the requested information, such as a web page or link, without having to point or click a mouse, i.e. a substantially hands-free operation.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary operating environment according to embodiments of the present invention;

FIG. 2 illustrates an exemplary computing system for embodiments of the present invention;

FIG. 3 illustrates another exemplary operating environment according to embodiments of the present invention;

FIGS. 4A-4C depict front, side, and rear views of a voice-enabled transceiver, according to embodiments of the invention;

FIG. 5 depicts a flow diagram according to an embodiment of the present invention;

FIGS. 6A-6B depict front and rear views of a voice-enabled transceiver, according to other embodiments of the invention; and,

FIGS. 7A-7B depict front and rear views of a voice-enabled transceiver, according to yet other embodiments of the invention.

### DETAILED DESCRIPTION

As briefly described above, embodiments of the present invention are directed to methods and systems for accessing information across a network, such as the Internet. The methods and systems utilize a key word identifier (KWI) application and a voice-enabled transceiving device to access information across a network. Embodiments of the invention allow a user to locate a web link or page without having to type a uniform resource locator (URL) or Internet protocol (IP) address. In one embodiment, a user may use a computer having a KWI module or voice-enabled software which directs the user to a specified web site(s) or related web link(s). Various embodiments of the invention utilize software and hardware to receive and process analog voice signals into associated formats. The processed voice signals are used to locate information, such as a URL or IP address on a network, without the user having to type in commands on a keyboard or other input device. In certain embodiments a user may access a web page by issuing voice commands into a microphone of a voice-enabled modem having a KWI application. For example, suppose a user would like to receive sports related information. To get a web page the user might say “sports link.” The KWI application running on the user's computer in conjunction with a processor of the voice-enabled modem operate to recognize key words and obtain information from a network, such as a web page or link(s).

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

Operating Environment

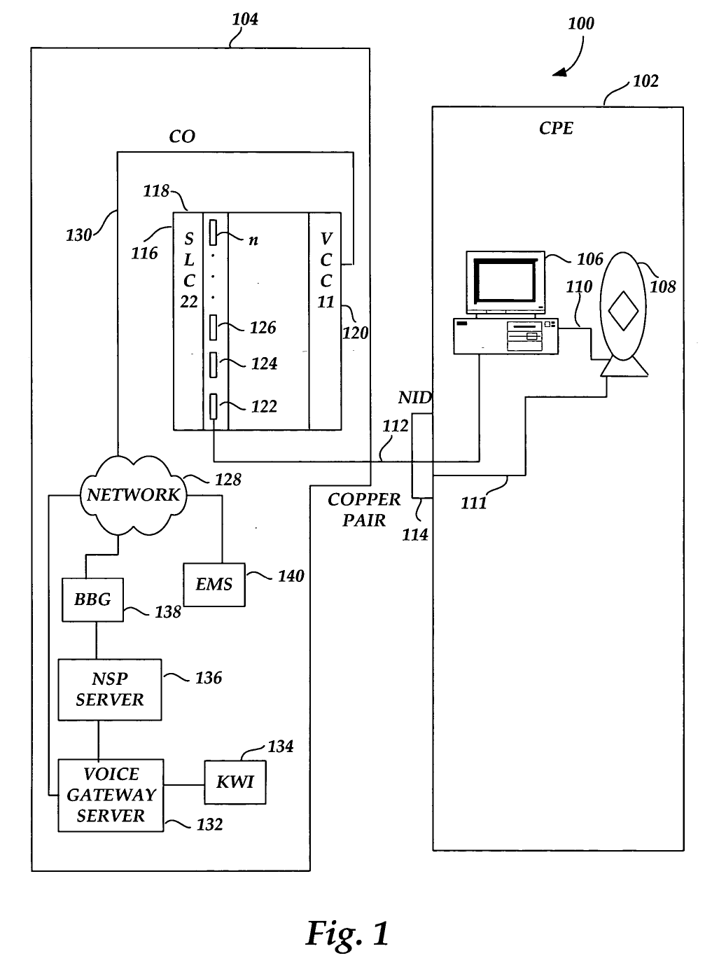

Referring now to the drawings, in which like numerals represent like elements through the several figures, embodiments of the present invention and the exemplary operating environment will be described. FIGS. 1-3 and the following discussion are intended to provide a brief, general description of suitable operational environment(s) in which the invention may be implemented. As illustrated, according to an embodiment of the invention, an exemplary operating environment 100 includes customer premise equipment 102 and a central office 104. It will be appreciated that the operating environment 100 may include multiple numbers of customer premise equipment available to different customers and multiple central offices in communication with one or more customers using customer premise equipment.

As shown in FIG. 1, exemplary customer premise equipment 102 may include a computer 106 and a voice-enabled transceiver 108, described further below, in communication with the computer 106 via link 110. The link 110 may represent wireline or wireless communication between the computer 106 and the voice-enabled transceiver 108. The voice-enabled transceiver 108 is in communication with the link 110 via link 111, typically an RJ-11 connection.

While the invention will be described in the general context of program modules or applications that execute in conjunction with an application program that runs on an operating system on a computer 106, those skilled in the art will recognize that embodiments of the invention may also be implemented in combination with other program modules. Generally, program modules or applications include routines, programs, components, data structures, and other types of structures that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

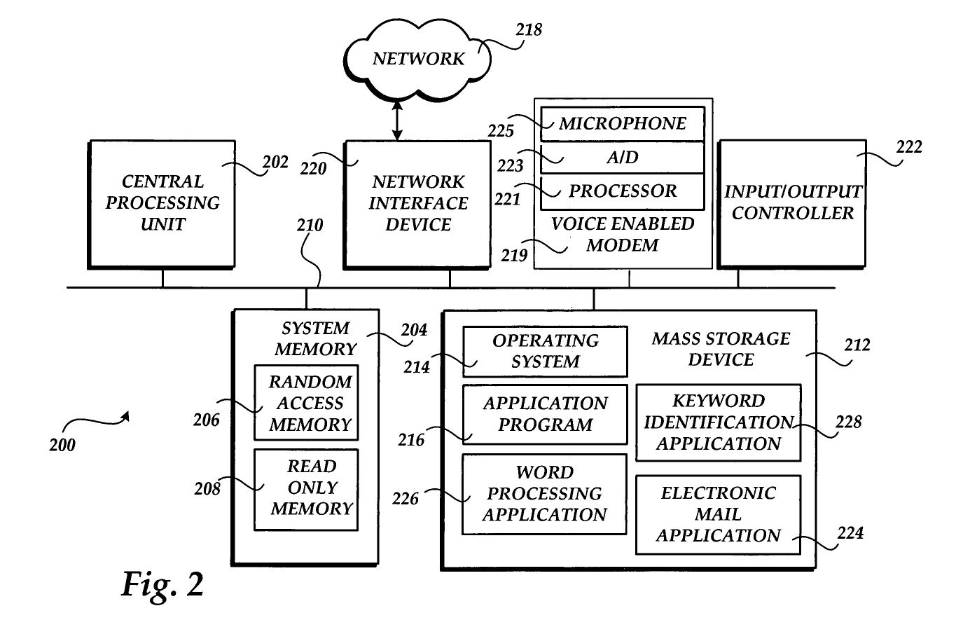

With additional reference now to FIG. 2, an illustrative computer architecture for a computer 200, such as computer 100 of FIG. 1, for practicing various embodiments of the invention is described. The computer architecture shown in FIG. 2 includes a central processing unit 202 (“CPU”), a system memory 204, including a random access memory 206 (“RAM”) and a read-only memory (“ROM”) 208, and a system bus 210 that couples the memory 204 to the CPU 202. A basic input/output system containing the basic routines that help to transfer information between elements within the computer, such as during startup, is stored in the ROM 208. The personal computer 200 further includes a mass storage device 212 for storing an operating system 214, application programs, such as the application program 216, and data.

The mass storage device 212 is typically connected to the CPU 202 through a mass storage controller (not shown) connected to the bus 210. The mass storage device 212, such as a hard disk, and its associated computer-readable media, provide non-volatile storage for the personal computer 200. By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer 200.

As shown in FIG. 2, the personal computer 200 may operate in a networked environment using logical connections to remote computers through a TCP/IP network 218 or other network. The personal computer 200 may connect to the TCP/IP network 218 through a network interface device 220 connected to the bus 210. It should be appreciated that the network interface device 220 may also be utilized to connect to other types of networks and remote computer systems, such as local, wide-area, peer-to-peer, and other networks.

According to embodiments of the invention, a voice-enabled modem 219wh is operatively in communication with the computer 200, via bus 210 or USB port. While embodiments of the invention refer to a voice-enabled modem, it will be appreciated that the invention is not limited to modems, but also encompassed other types of transceiving devices as well, described further below. The voice-enabled modem 219 includes a processor 221 and an analog to digital converter (A/D) 223. The A/D 223 is connected to a microphone 225 and operates to convert input analog voice commands to a digital signal representation.

The processor 221, in conjunction with a keyword identification (KWI) application program 228, operates to process analog voice commands input to the voice-enabled modem 219. The processor 221 operates to execute a collection of instructions coded in the KWI application 228, converting the voice command to a packetized signal including a specific header, described below. The personal computer 200 may also include an input/output controller 222 for receiving and processing input from a number of devices, including a keyboard or mouse (not shown). Similarly, the input/output controller 222 may provide output to a display screen, a printer, or other type of output device.

As described above, a number of program modules and data files may be stored in the mass storage device 212 and RAM 206 of the personal computer 200, including the operating system 214 suitable for controlling the operation of a networked personal computer 200. The mass storage device 212 and RAM 206 may also store one or more application programs (modules). In particular, the mass storage device 212 and RAM 206 may store the application program 216 for providing a variety of functionalities to a user. By way of example, and not limitation, the application program 216 may comprise many types of programs such as an electronic mail (e-mail) application program 224, a word processing application program 226, a database application program, and the like. According to embodiments of the present invention, the KWI application program 228 is utilized to convert voice commands to packetized instructions for retrieving information across the network 218, as described herein.

Referring again to FIG. 1, the central office 104 of the exemplary operating environment 100 is in communication with the customer premise equipment (CPE) 102 via a copper wire pair 112. The CPE 102 may provide dial-up access to the network 128 or, more commonly, may provide a digital subscriber line (DSL) connection. The copper wire pair 112 is connected to the internal wiring of the user's premises through network interface device (NID) 114. As shown in FIG. 1, the central office 104 includes a subscriber line multiplexer 116 in communication with the copper wire pair 112. It will be appreciated that multiple copper wire pairs may be in communication with the subscriber line multiplexer 116. According to an embodiment, the subscriber line multiplexer 116 includes at least one subscriber line card (SLC) 118 for interfacing with a user's (subscriber) line. The subscriber line multiplexer 116 also includes a voice control card (VCC) 120 for aggregation package switching and a plurality of transceiving devices 122, 124, 126, . . . , n.

The subscriber line multiplexer 116 is in communication with a network 128, such as an asynchronous transfer mode (ATM) network, via link 130. Link 130 may be any link, such as an optical carrier link or T-3 (DS-3) line, operable to transport signals between the subscriber line multiplexer 116 and the network 128. As shown in FIG. 2, a network service provider (NSP) server 136 is in communication with a broadband gateway (BBG) 138. The BBG 136 provides other services to users of the system 100, such as multiple sessions, more security, or enhanced aggregation. The NSP server 136 enables a user to connect to a network, such as the Internet, once certain information is input, such as a username and password.

According to embodiments of the invention, a voice gateway server (VGS) 132 is also in communication with the network 128, and recognizes protocols having the specific header attached by the voice-enabled transceiver 108. The VGS 132 may be described as a general purpose computing system having components including an operating system, a processor and memory space as described above for the computer 200 illustrated and described with reference to FIG. 2. The VGS 132 also includes a server KWI application 134 operable to recognize the packetized instructions transmitted from the CPE 102 and retrieve information, such as a web link, web page, and/or IP addresses, from the network 128. The VGS 132 may attach a destination address, such as an uniform resource locator (URL) and/or Internet protocol (IP) address to a signal before transmitting the modified signal back to the CPE 102. The VGS 132 performs a similar function as if a user had typed in a URL or IP address at the CPE 102.

However, the VGS 132, using the KWI application 134, recognizes commands input as voice commands at the voice-enabled transceiver 108 of the CPE 102 and converts those commands to protocol signals recognizable by the NSP server 136. Preferably, the KWI application 134 of the VGS 132 recognizes key terms associated with user requested information, such as requested web links for example, and requests the information from the network 128 using known protocols, such as TCP/IP, UDP, etc. Information, such as a web page, link, or other information is transmitted back to the user's CPE 102, based upon the user's voice commands spoken into the voice-enabled modem 219.

The system 100 also includes an element management system (EMS) 140 in communication with the network 128. The EMS 140 provides maintenance and provisioning capability. The EMS 140 is typically a graphical user interface allowing an administrator to see what is happening by viewing traffic being passed on a given port and to make sure the traffic is upstream and downstream of the user of the CPE 102.

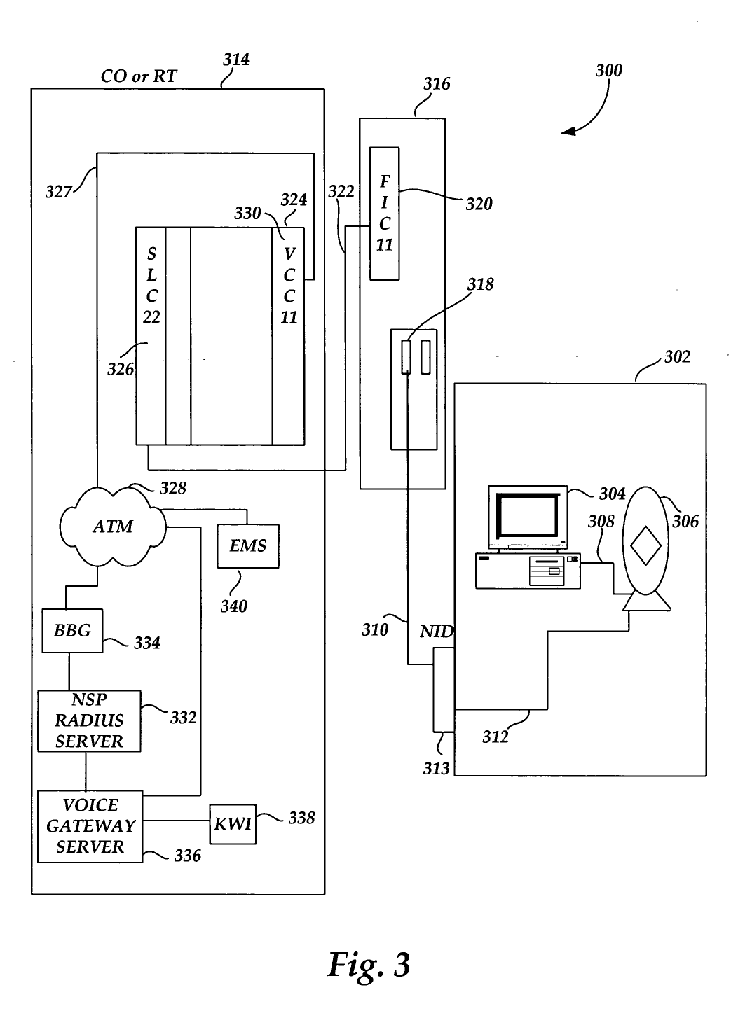

Referring now to FIG. 3, an exemplary fiber optic operating environment 300 is shown. As shown in FIG. 3, exemplary customer premise equipment 302 may include a computer 304, and a voice-enabled modem 306 in communication with the computer 304 via link 308. The link 308 may represent wireline or wireless communication between the computer 304 and the voice-enabled modem 306. The voice-enabled modem 306 is capable of operating using voice over Internet protocol (VoIP) technology to access information from a network 328, such as the Internet. The modem 306 is in communication with a copper pair 310 via link 312 which is typically an RJ-11 connection. Computer 304 connects to a network, such as a TCP/IP or other network, at a network interface device (NID) 313 which couples the customer premise's wiring with the copper pair 310.

A central office (CO) 314 or remote terminal (RT) of the exemplary operating environment 300 is in communication with the customer premise equipment (CPE) 302 via an optical network unit (ONU) 316. The ONU 316 includes a binding post 318 in communication with the copper pair 310. The ONU 316 further includes a fiber interface card (FIC) 320 for converting electrical signals to optical and vice versa. The FIC 320 is in communication with the CO 314 via fiber link 322.

The central office 314 includes a fiber multiplexer 324 in communication with an ATM or other network 328 via fiber link 327. The fiber multiplexer 324 may include at least one subscriber line card (SLC) 326 for interfacing with the ONU 316 via fiber 322. The fiber multiplexer 324 also includes a voice control card (VCC) 330 for aggregation package switching. A network service provider (NSP) RADIUS server 332 is in communication with a broadband gateway (BBG) 334 which is in communication with the network 328. The BBG 334 provides other services to users of the system 300, such as multiple sessions, more security, or enhanced aggregation. The NSP server 332 enables a user to connect to the network 328, once certain information is input, such as a username and password.

According to embodiments of the invention, a voice gateway server (VGS) 336 is also in communication with the network 328. The VGS 336 is operable to recognize communication protocols having a specific header transmitted with the signal from the voice-enabled modem 306. The VGS 336 also includes a server KWI application 338 operable to recognize the packetized instructions transmitted from the CPE 302 and retrieve information, such as a web link, web page, and/or IP addresses, from the network 328. The VGS 336 can attach a destination address, such as an uniform resource locator (URL) and/or Internet protocol (IP) address to a signal before transmitting the modified signal back to the CPE 302. The VGS 336 performs a similar function as if a user had typed in a URL or IP address at the CPE 302.

As described above, the VGS 336, using the KWI application 338, recognizes commands input as voice commands at the voice-enabled modem 306 of the CPE 302 and converts those commands to protocol signals recognizable by the NSP server 332. Preferably, the KWI application 338 of the VGS 336 recognizes key terms associated with user requested information, such as requested web links for example, and requests the information from the network 328 using known protocols, such as TCP/IP, UDP, etc. Information, such as a web page, link, or other information is transmitted back to the user's CPE 302, based upon the user's voice commands spoken into the voice-enabled modem 306.

The CO 314 also includes an element management system (EMS) 340 in communication with the network 328. The EMS 340 provides maintenance and provisioning capability. As described above, the EMS 340 is typically a graphical user interface allowing an administrator to see what is happening by viewing traffic being passed on a given port and to make sure the traffic is upstream and downstream of the user of the CPE 302.

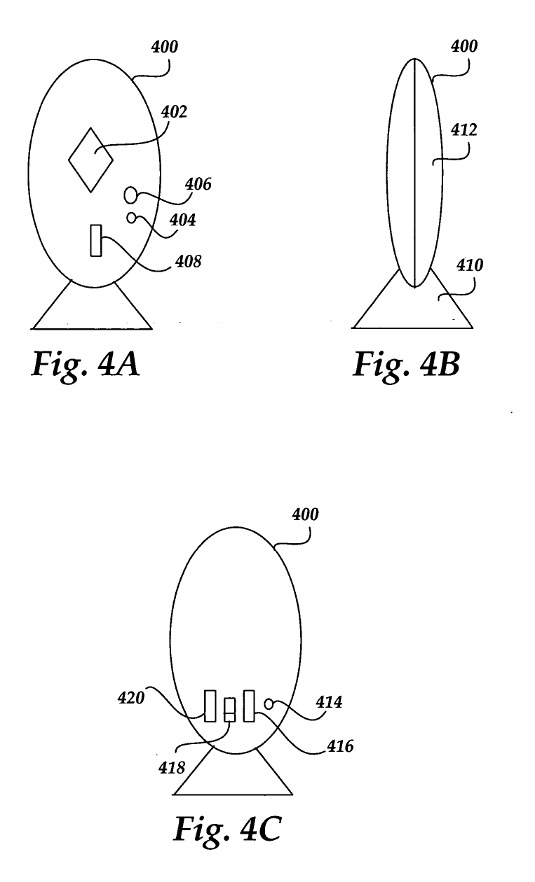

With reference now to FIGS. 4A-4C, an exemplary voice-enabled modem 400 is shown. As with the voice-enabled modem 219 described above in reference to FIG. 2, the voice-enabled modem 400 preferably includes an A/D converter and a processor for processing voice commands issued by a user. FIG. 4A depicts a front view of the exemplary voice-enabled modem 400. The voice-enabled modem 400 includes a microphone 402 operable to receive voice commands from a user, presenting an analog signal to the A/D converter, described above. The voice-enabled modem 400 also includes a power indicator 404, such as an LED or similar device.

The voice-enabled modem 400 also includes a sync light indicator 406, operable to alert a user that the voice-enabled modem 400 has synched up with the central office multiplexing equipment. The voice-enabled modem 400 is designed to achieve a high-speed connection to a multiplexer or other equipment at a central office. A microphone adjustment button 408 enables a user to adjust the microphone volume level. FIG. 4B is a side view of the voice-enabled modem 400, depicting a base 410 which supports a body portion 412 of the voice-enabled modem 400.

Referring to FIG. 4C, a rear view of the voice-enabled modem 400 is shown. A power connection 414 provides an input for an AC or DC power source. The voice-enabled modem 400 also includes a connection 416, such as an RJ-11 connection, for connecting to the network interface device, described above. A USB connection 418 enables a computer to be connected to the voice-enabled modem 400. Alternatively, a CAT-5 connection 420 may be used to enable a computer to be connected to the voice-enabled modem 400.

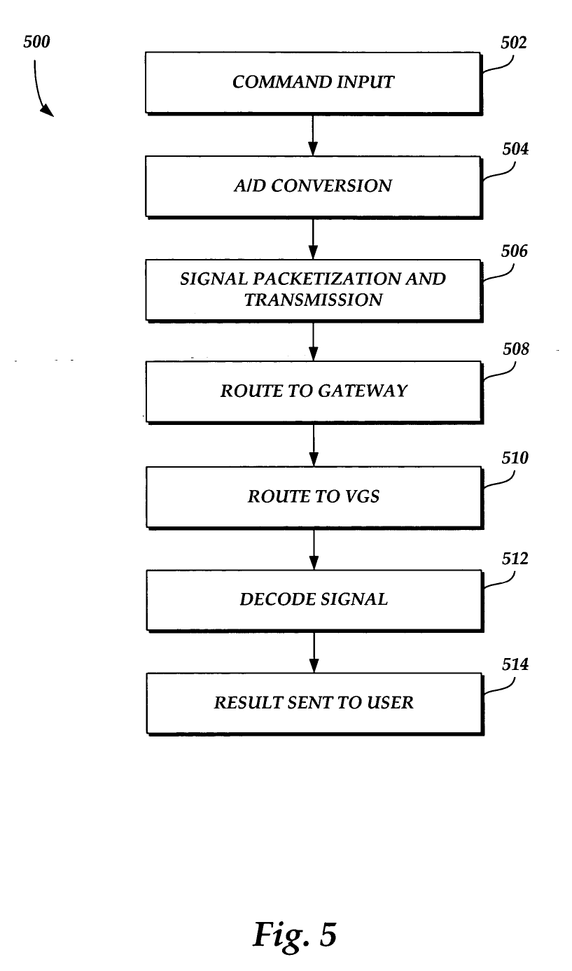

A flow diagram depicted in FIG. 5 illustrates a method 500 of accessing information across a network, such as the Internet, according to embodiments of the present invention. At 502, a user articulates a command into the microphone 402 of the voice-enabled modem 400. For example, the user may be interested in sports-related links, and therefore articulates a command such as “sports” into the microphone 402. The analog voice signal is first converted to a digital representation at 504. Referring again to FIGS. 1 and 2, using the KWI application 228, the processor 202, at 506, packetizes the digital signals into discrete signal packets. In one embodiment, the KWI application 228 may include a list of common or popular web sites within the application code such as: news, sports, weather, finances, maps, and the like. The digital signal representation may be sent to a file on the computer 200, wherein the server KWI application 134 attempts to match the digital representation signal to a list within the file to find a code that matches the digital representation.

The computer 200 then transmits the signal packets to the multiplexer 116. According to one embodiment, the signal packets include one or more codes associated with the digital representation described above. At 508, the signal packets arrive at the BBG 138. The BBG 138, at 510, routes the signal packets to the VGS 132. Using the server KWI application 134, the VGS 132, at 512, decodes the signal packets to obtain a number of URLs and/or IP addresses according to what the user requested. In one embodiment, the VGS 132 receives the software packets along with the one or more codes, associated with a requested web page, for example. The web page was sent in the coded software packets, described above.

The VGS 132 may include a number of files and/or databases that it uses to locate a second code that substantially matches the code in the transmitted software packets from the user's computer 200. Once the VGS 132 identifies a substantially matching code, it attaches a corresponding destination address, such as an URL and/or IP address to that code which at this point is associated with a web page, continuing the example. For instance, if the user requested a “sports” link, the VGS 132 will communicate with the Internet to pull down a web page and/or associated web links. At 514, the web page or link(s) is sent to the user's computer 200 for viewing and selection. To the user, the process appears as if the user had used the keyboard to type in a request.

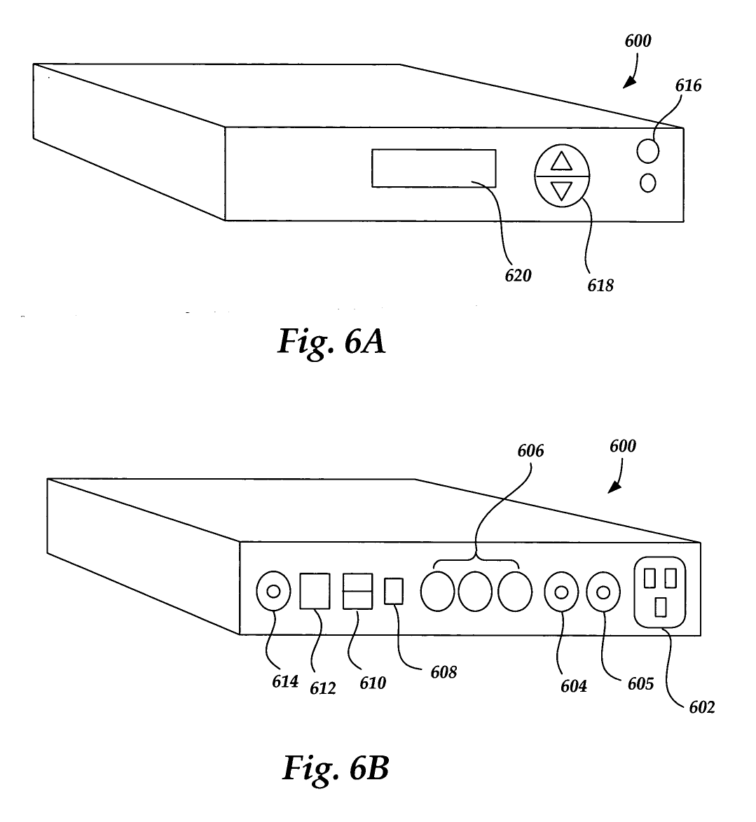

Referring now to FIGS. 6A-6B, front and rear views of a voice-enabled cable modem 600 is shown according to embodiments of the invention. As shown in the rear view, the voice-enabled cable modem 600 includes a power input 602, microphone 604, speaker connector 605, RCA connectors 606, RJ-11 connector 608, USB connector 610, RJ-45 connector 612, and a coaxial connector 614. As shown in the front view, the voice-enabled cable modem 600 also includes a power indicator 616, such as an LED(s), a channel selector 618, and a display 620.

The voice-enabled cable modem 600 will function in similar fashion to the embodiments described above. Using the voice-enabled cable modem 600, a series of commands may be spoken into a microphone 604. Optionally a microphone may attached to the rear of the voice-enabled cable modem 600 using the USB port 610. The voice-enabled cable modem 600 in conjunction with a Key Word Identification (KWI) application operates to convert a spoken voice command into an equivalent binary or other code. The voice-enabled cable modem 600 operates to substantially match the code against a file running on the subscriber's computer. As described above, the code is sent upstream over a coax cable which voice, data and video signals will propagate on different frequency channels within the coaxial cable once the signal is received by the (VGS) Voice Gateway Server 132 or 336. The VGS operates to substantially match the code to an equivalent destination address, such as an URL or IP address that will then be routed back to the user's computer with the web link that was requested. Once the radius server 136 or 332 issues the subscriber a destination address from an address pool, the subscriber may then be authenticated. It will be appreciated that the above-described embodiments also may operate using VoIP (Voice Over IP) technology.

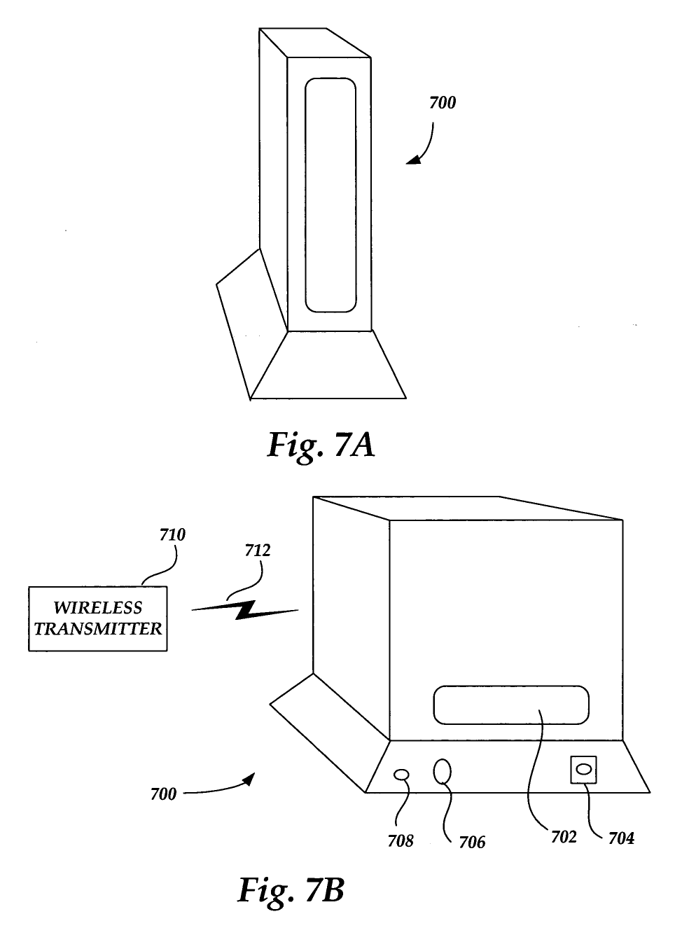

Referring now to FIGS. 7A-7B, side and rear views of a voice-enabled wireless router 700 is shown according to embodiments of the invention. As shown in the rear view, the voice-enabled wireless router 700 includes microphone 702, power input 704, external microphone connector 706, and a sync light 708. A voice command may be spoken into the voice-enabled wireless router 700 which processes the voice command into an equivalent binary or other code. The processor, such as processor 202 described above, of the voice-enabled wireless router 700 includes operability to send the processed signal to a wireless transmitter 710 in the form of a WI FI or other signal that can be received and processed. The wireless transmitter 710 will receive the signal and convert it to an equivalent WI FI signal, and then route it back to the user containing the web page or link that was requested through the voice-enabled wireless router 700. The voice-enabled wireless router 700 also utilizes a keyword identification (KWI) application to convert the spoken voice command into an equivalent binary or other code for the selected web page or link.

As described herein, methods and systems are provided for accessing information over a network utilizing a voice-enabled transceiver and a voice gateway server, each including a keyword identifier application. According to alternative embodiments of the invention, the KWI application may reside in the voice-enabled transceiver itself, thereby operating a stand-alone device for retrieving information from a network. According to other embodiments of the invention, a stand alone device having the KWI application or a device operable to communicate with a computer running the KWI application may be used to receive voice commands and operate to retrieve information from a network. These devices may be utilized where modulation and demodulation functions are not required. In other alternative embodiments, users of the system may access e-mail by issuing voice commands into a device utilizing the KWI application to access the user's e-mail from an e-mail server. As described above, the present invention may also be implemented using voice over Internet protocol (VoIP) and other communication technology. Additionally, the system and method may include a software application for opening and closing web pages with a series of scripts that run from the user's computer, allowing for hands free operation while opening and closing web pages.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A system for accessing information over a network, comprising:
a communication device including:
an input for receiving an analog signal representing information requested from the network,
an analog to digital (A/D) converter for converting the analog signal to a digital signal representation,
an output, and
a processor for processing the digital signal representation, and
a computing system in communication with the output of the communication device, the computing system including:
a processor, and
a memory including an application used in conjunction with the processor of the communication device for recognizing aspects of the digital signal representation.

2. The system of claim 1 wherein the communication device comprises a voice-enabled modem.

3. The system of claim 1 wherein the communication device comprises a voice-enabled wireless device.

4. The system of claim 1 wherein the system is operable to retrieve a web page from the network based on a voice command received by the input of the communication device.

5. The system of claim 1 wherein the system is operable to retrieve a web link from the network based on a voice command received by the input of the communication device.

6. The system of claim 1 further comprising a server in communication with the computing system for locating a web page and/or a web link based on a voice command received by the communication device.

7. The system of claim 6 wherein the server further comprises an application operable to recognize packetized instructions transmitted from the computing system and retrieve information from the network based thereon.

8. The system of claim 7 wherein the server further comprises a key word identification application for recognizing keywords associated with the packetized instructions transmitted from the computing system.

9. The system of claim 1 wherein the memory of the computing system includes a key word identification application for recognizing keywords associated with the digital signal representation.

10. A voice gateway server (VGS) system for accessing information over a network, comprising:
a processor;
a memory including a keyword identification (KWI) application; and
an input for receiving signal packets including one or more codes associated with a verbalized user request for information,
the KWI application for decoding the signal packets to obtain the requested information.

11. The system of claim 10, wherein the KWI application is further operable to decode the signal packets to obtain a uniform resource locator (URL) and/or Internet protocol (IP) address associated with the verbalized user request for information.

12. The system of claim 10, wherein the VGS is operable to transmit the requested information to a computer system having a voice-enabled transceiver.

13. The system of claim 11, wherein the VGS is operable to transmit signal packets including a URL and/or IP address associated with the verbalized user request for information to a computer system having a voice-enabled transceiver.

14. The system of claim 10, the VGS further comprising a number of files and/or databases used for locating a code associated with the received software packets.

15. The system of claim 10, the VGS further comprising voice over Internet protocol (VoIP) operability.

16. A computer-readable medium containing computer-executable instructions which when executed by a computer perform a method for accessing information over a network, the method comprising:
reading a digital signal having a first code associated with a voice signal input to a voice-enabled communication device,
locating a second code associated with the first code, and
identifying a destination address based on a comparison of the first and second codes.

17. The computer-readable medium of claim 16, the method further comprising reading a digital signal associated with a voice signal input to a voice-enabled communication device.

18. The computer-readable medium of claim 16, the method further comprising encoding a packetized signal to be transmitted from a system including a voice-enabled modem or wireless device.

19. The computer-readable medium of claim 16, the method further comprising reading a packetized signal having one or more codes transmitted from a system including a voice-enabled modem or wireless device.

20. The computer-readable medium of claim 16, the method further comprising comparing the first code to a file list including a number of keywords.
